(19) United States
(12) Patent Application Publication
(10) Pub. No.: US 2024/0084838 A1
(43) Pub. Date: Mar. 14, 2024

(54) Threaded fastener

(71) Applicant: Wen-Pin Huang, Kaohsiung (TW)

(72) Inventor: Wen-Pin Huang, Kaohsiung (TW)

(21) Appl. No.: 18/380,215

(22) Filed: Oct. 16, 2023

(51) Int. Cl. F16B 33/02

(52) U.S. Cl. CPC F16B 33/02

(57) ABSTRACT

A fastener includes a bolt including a head and a threaded shank having a conic, bare section proximate the head, a threaded section having a plurality of annular ridges and a plurality of spiral grooves in the annular ridges; and a hollow member including a head and a shank. The hollow member is configured to dispose on the bolt with an end of the shank being urged by the conic, bare section. The spiral grooves are spaced apart 90-degree each other.

### BACKGROUND OF THE INVENTION

### 1. Field of the Invention

The invention relates to fasteners and more particularly to a threaded fastener having improved characteristics including an increased fastening force.

### 2. Description of Related Art

Conventional threaded fasteners having a bolt and a hollow member are disadvantageous because the fastening force exerted on a work piece by the threaded fastener is not sufficient. It is typical that the work piece may be loosened.

Thus, the need for improvement still exists.

### SUMMARY OF THE INVENTION

It is therefore one object of the invention to provide a fastener comprising a bolt including a head and a threaded shank having a conic, bare section proximate the head, a threaded section having a plurality of annular ridges and a plurality of spiral grooves in the annular ridges; and a hollow member including a head and a shank; wherein the hollow member is configured to dispose on the bolt with an end of the shank being urged by the conic, bare section.

Preferably, the spiral grooves are spaced apart 90-degree each other.

Preferably, the head of the hollow member is internally threaded.

The invention has the following advantages and benefits in comparison with the conventional art:

The spiral grooves can increase a fastening force when the hollow member and the bolt are assembled.

The inner surface of the head of the hollow member is deformed by the annular ridges when the hollow member and the bolt are assembled.

The above and other objects, features and advantages of the invention will become apparent from the following detailed description taken with the accompanying drawings.

### BRIEF DESCRIPTION OF THE DRAWINGS

FIG. 1 is a perspective view of a bolt of a threaded fastener according to a first preferred embodiment of the invention;

FIG. 2 is side elevation of the bolt;

FIG. 3 is a front end view of the bolt;

FIG. 4 is a perspective view of an elongated, hollow member of the threaded fastener;

FIG. 5 is a side elevation of the elongated, hollow member;

FIG. 6 is a sectional view taken along line 6-6 of FIG. 5;

FIG. 7 shows the bolt and the elongated, hollow member to be assembled;

FIG. 8 is a view similar to FIG. 7 where the elongated, hollow member is shown partially broken away;

FIG. 9 is a perspective view of the bolt and the elongated, hollow member assembled as the threaded fastener;

FIG. 10 is a side elevation of the threaded fastener in FIG. 9;

FIG. 11 is a sectional view taken along line 11-11 of FIG. 10;

FIG. 12 is a perspective view of a threaded fastener according to a second preferred embodiment of the invention;

FIG. 13 is a side elevation of the threaded fastener; and

FIG. 14 is a sectional view taken along line 14-14 of FIG. 13.

### DETAILED DESCRIPTION OF THE INVENTION

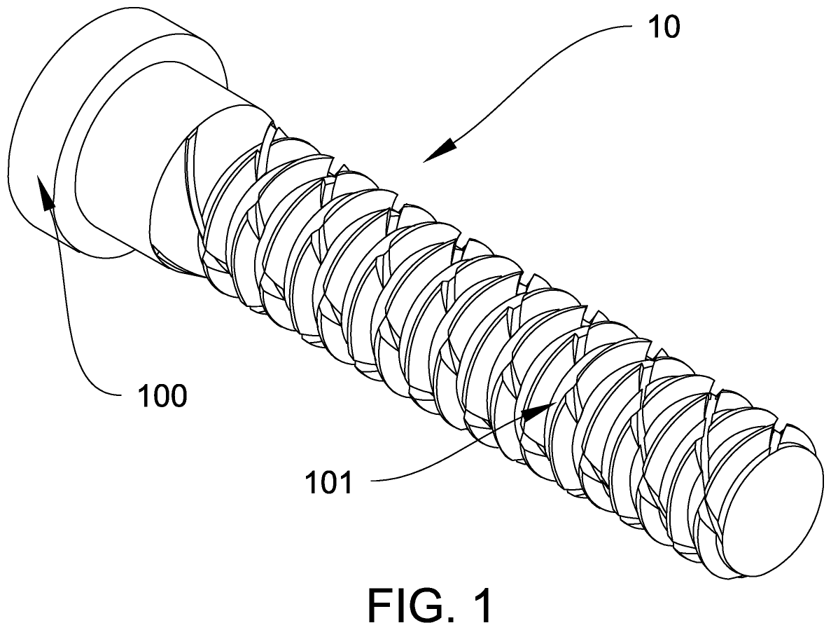

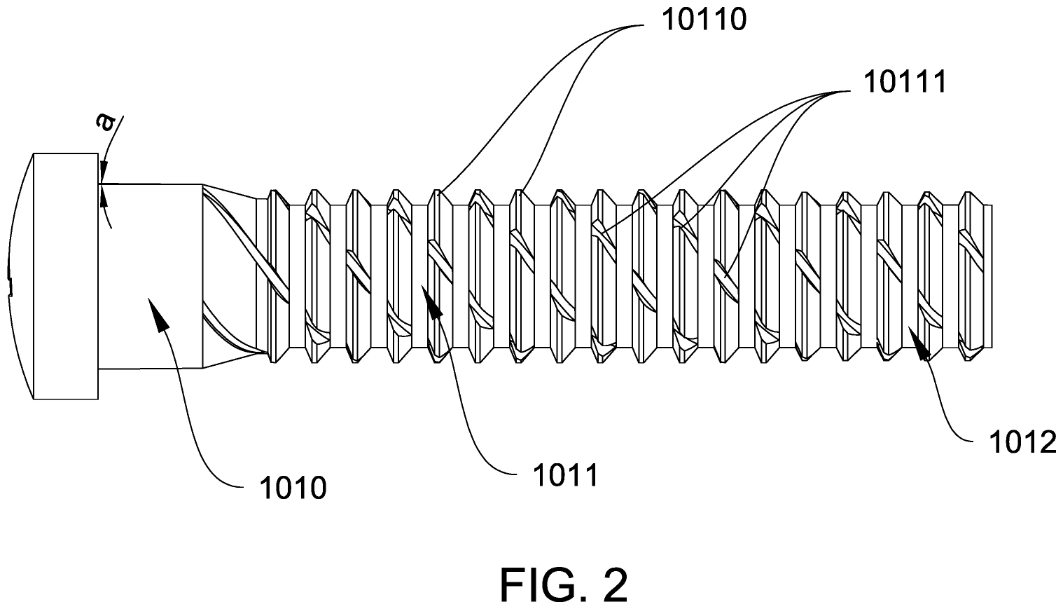

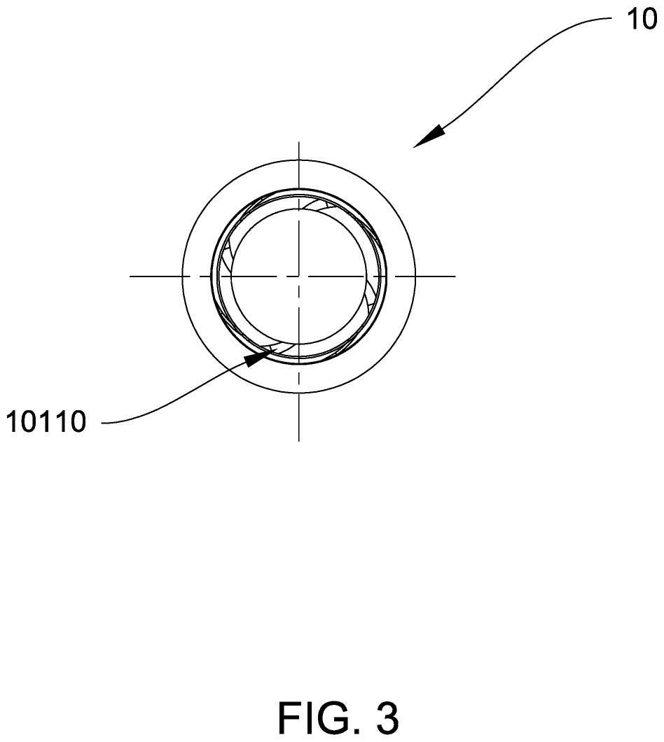

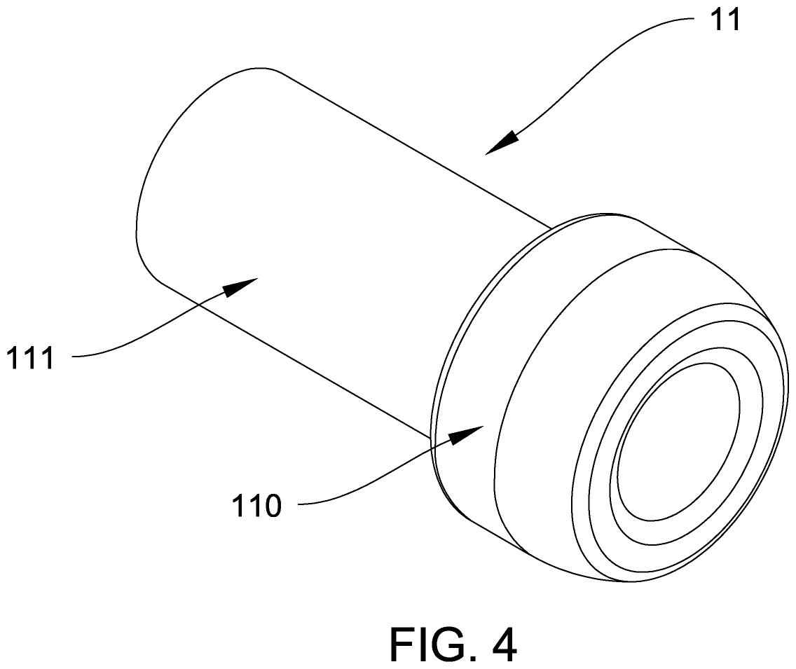

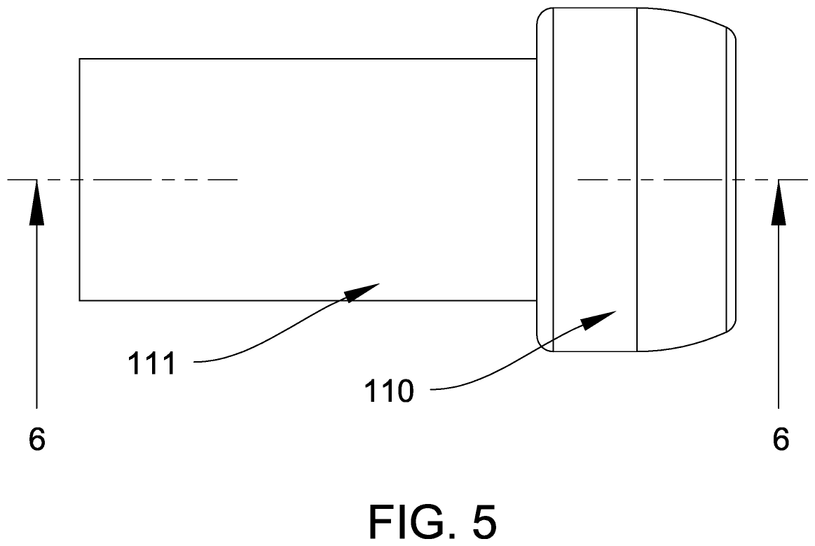

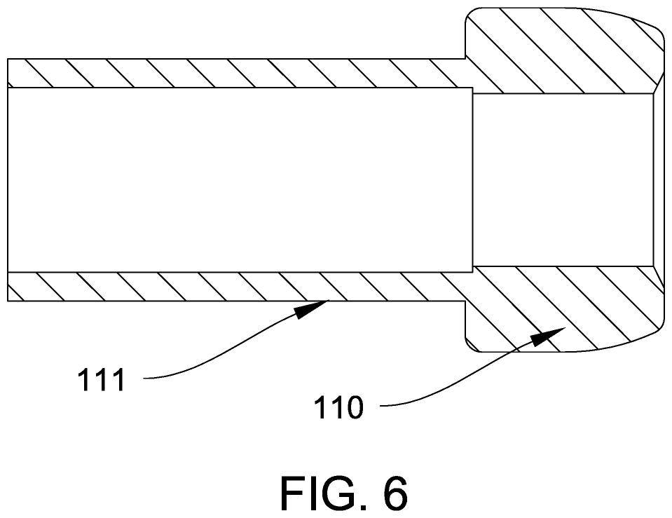

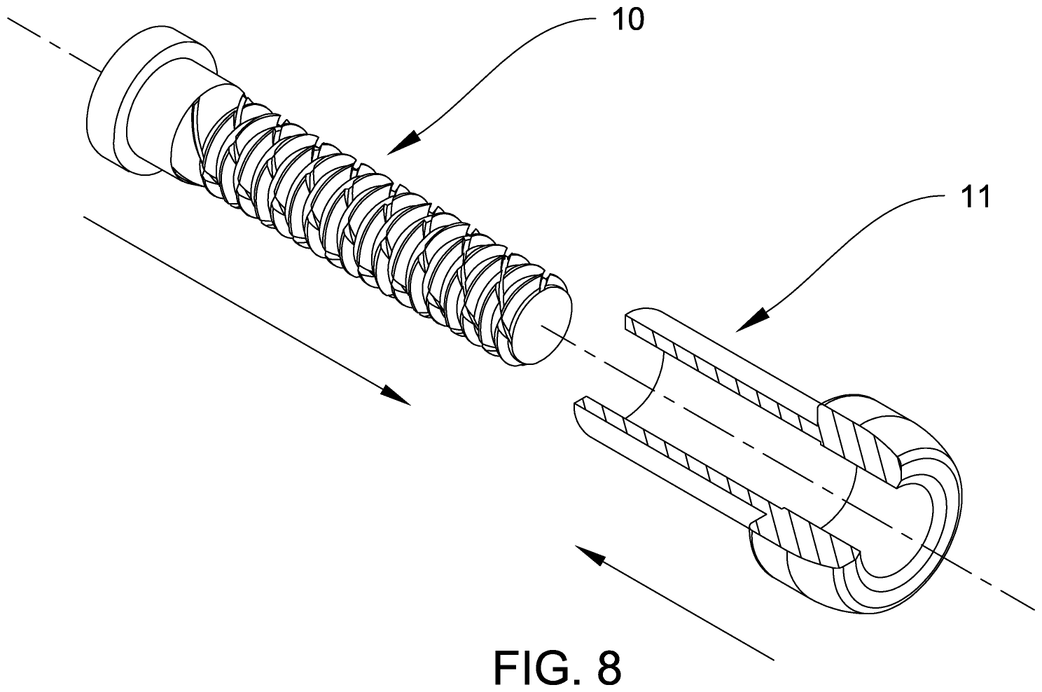

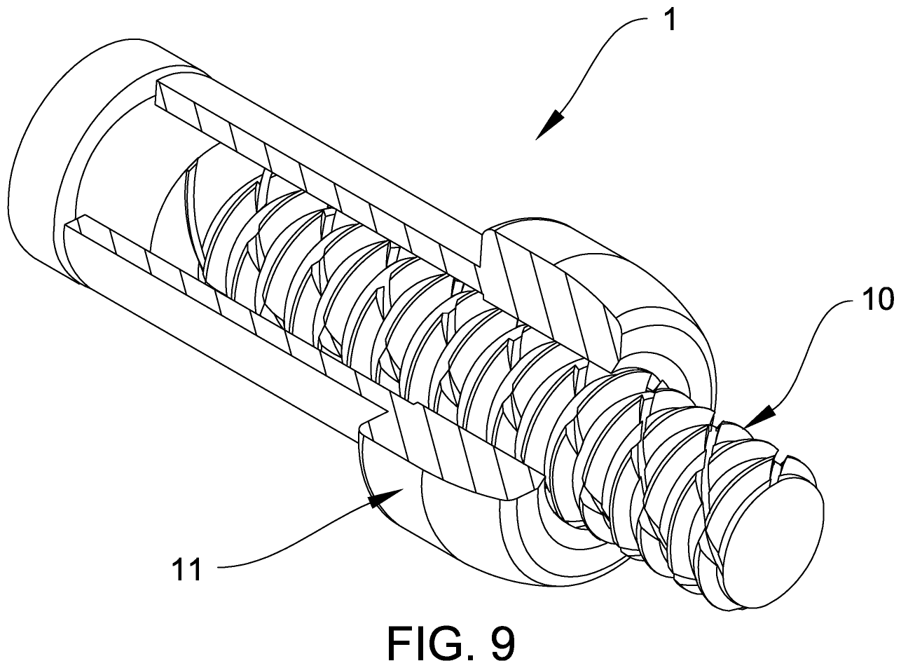

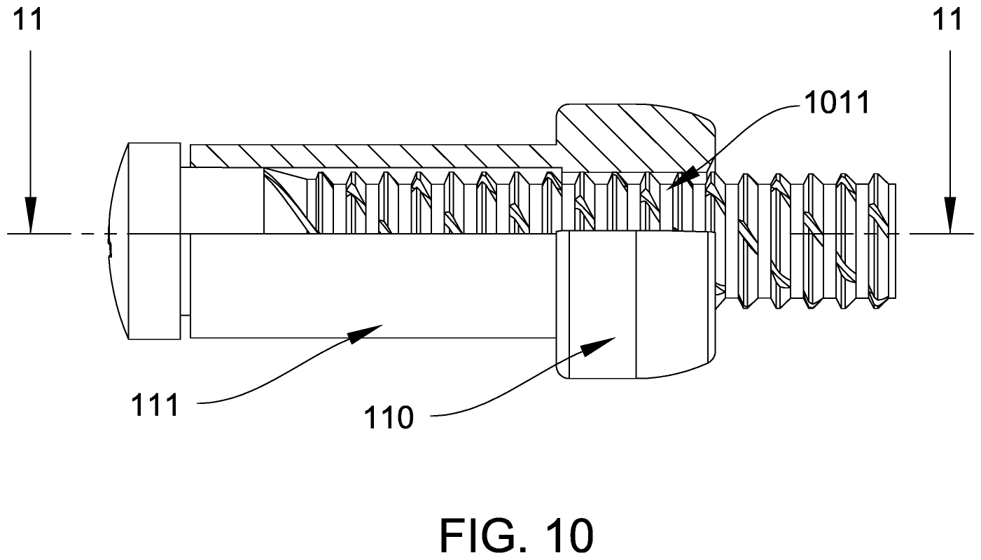

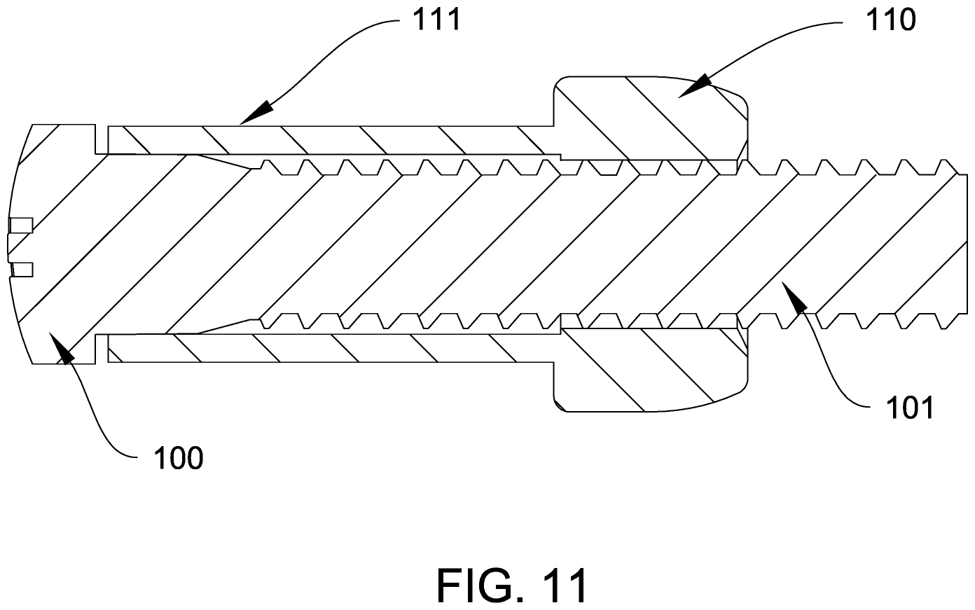

Referring to FIGS. 1 to 11, a threaded fastener 1 in accordance with a first preferred embodiment of the invention comprises a bolt 10 including an enlarged head 100 and a threaded shank 101 having a bare section 1010 proximate the head 100, the bare section 1010 being a cone having an inclined angle of a with respect to its axis, a threaded section 1011 having a plurality of annular ridges 10110 and a plurality of spiral grooves 10111 in the annular ridges 10110, and an end section 1012. The spiral grooves 10111 in the annular ridges 10110 are spaced apart 90-degree each other when viewing from a front end (see FIG. 3). The bolt 10 is structurally enhanced.

The threaded fastener 1 further comprises an elongated, hollow member 11 including an enlarged head 110 and a shank 111.

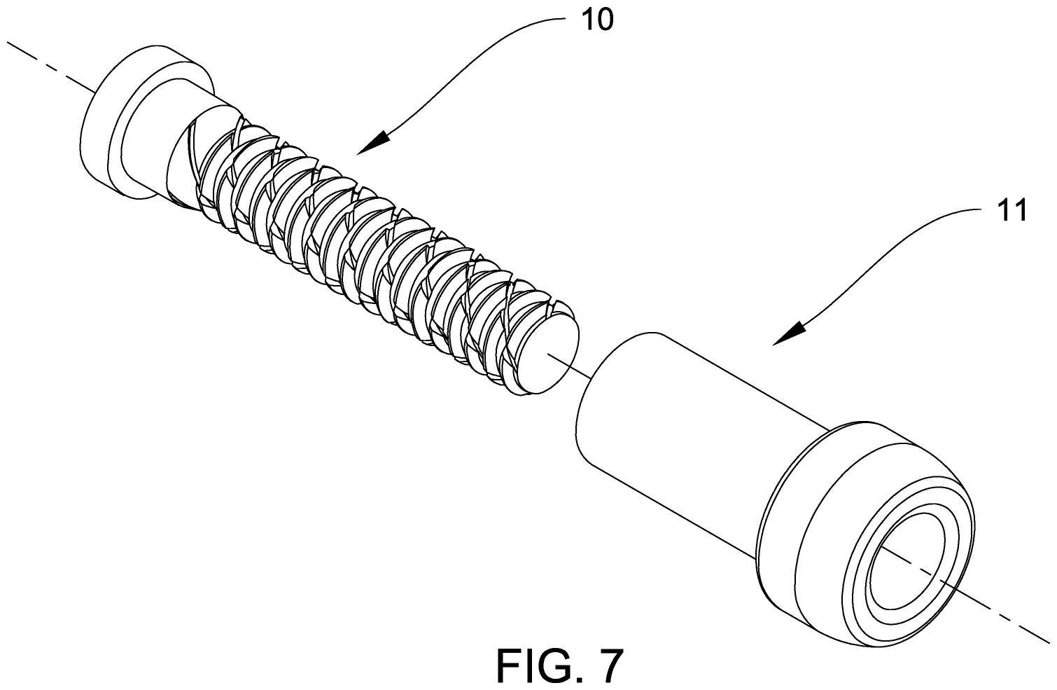

In assembly (see FIGS. 7 to 11), the elongated, hollow member 11 is put on the bolt 10 with an end of the shank 11 being urged by the conic bare section 1010. Also, an inner surface of the head 110 of the elongated, hollow member 11 is deformed by the annular ridges 10110 of the threaded section 1011. As a result, the threaded fastener 1 is fastened. It is noted that the spiral grooves 10111 can increase a fastening force when the elongated, hollow member 11 and the bolt 10 are assembled.

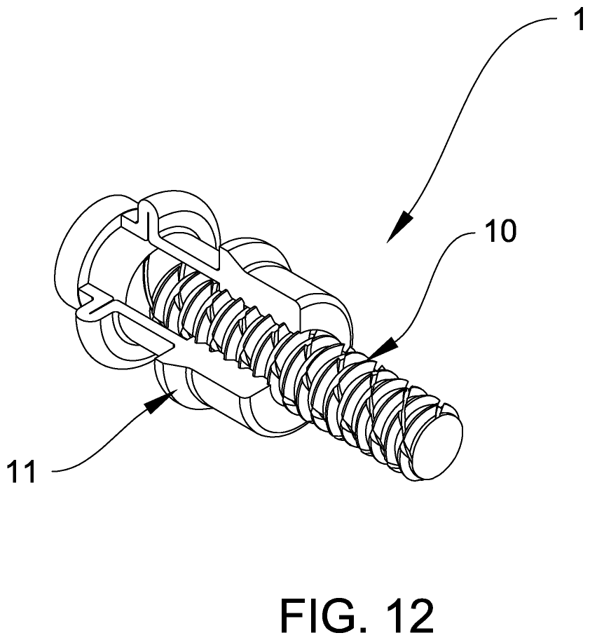

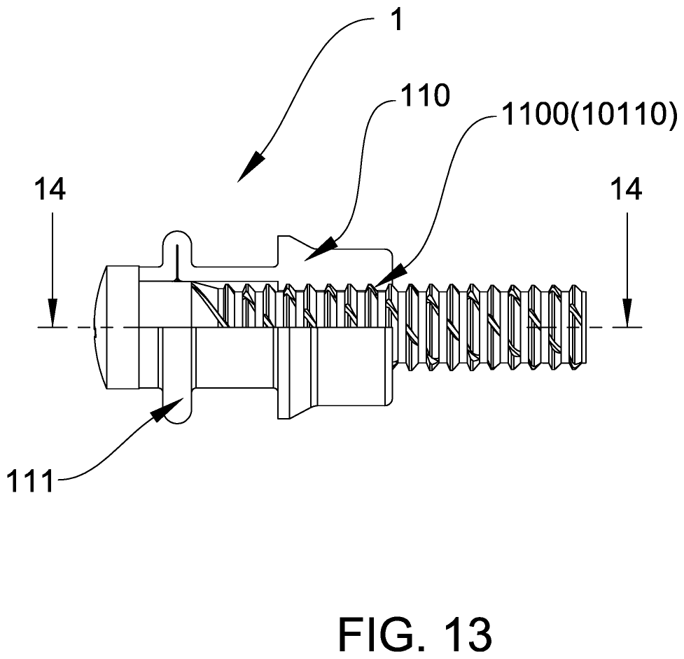

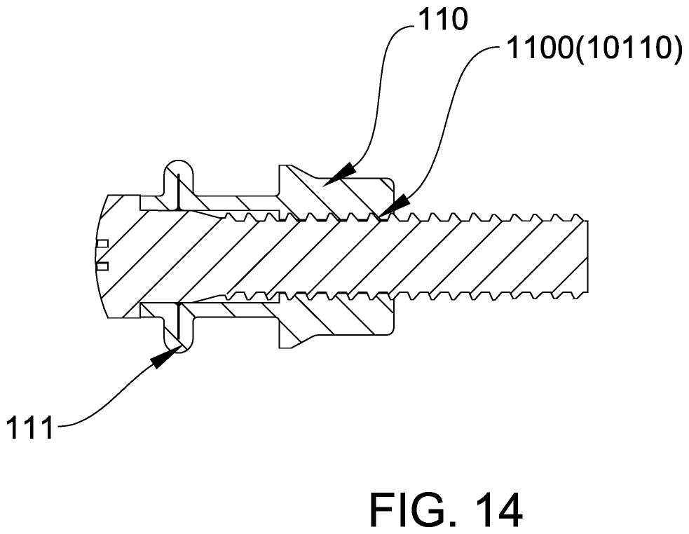

Referring to FIGS. 12 to 14, a threaded fastener 1 in accordance with a second preferred embodiment of the invention is shown. The characteristics of the second preferred embodiment are substantially the same as that of the first preferred embodiment except the following: the enlarged head 110 includes a threaded inner surface 1100 configured to threadedly secure to the annular ridges 10110.

While the invention has been described in terms of preferred embodiments, those skilled in the art will recognize that the invention can be practiced with modifications within the spirit and scope of the appended claims.

What is claimed is:

1. A fastener, comprising:
a bolt including a head and a threaded shank having a conic, bare section proximate the head, a threaded section having a plurality of annular ridges and a plurality of spiral grooves in the annular ridges; and
a hollow member including a head and a shank;
wherein the hollow member is configured to dispose on the bolt with an end of the shank being urged by the conic, bare section.

2. The fastener of claim 1, wherein the spiral grooves are spaced apart 90-degree each other.

3. The fastener of claim 1, wherein the head of the hollow member is internally threaded and configured to threadedly secure to the annular ridges.
